(19) United States
(12) Patent Application Publication
(10) Pub. No.: US 2025/0239584 A1
(43) Pub. Date: Jul. 24, 2025

(54) THERMOPLASTIC BASED COMPOSITE SINGLE LAYER ANODE IN SECONDARY BATTERIES

(71) Applicant: Izmir Egitim Saglik Sanayi Yatirim A.S., Bornova (TR)

(72) Inventors: Akin Isbilir, Manisa (TR); Berkay Metin Leskeri, Bornova (TR); Emre Can Bagcivan, Bornova (TR); Mehmet Sarikanat, Bornova (TR); Zekerya Dursun, Bornova (TR)

(21) Appl. No.: 18/698,622

(22) PCT Filed: Oct. 4, 2021
(86) PCT No.: PCT/TR2021/051013

§ 371 Date: Apr. 4, 2024

(51) Int. Cl. H01M 4/04; H01M 4/13; H01M 4/62; H01M 10/0525

(52) U.S. Cl. CPC H01M 4/0411; H01M 4/13; H01M 4/621; H01M 4/624; H01M 10/0525

(57) ABSTRACT

A reinforcement and/or filler element is added to the thermoplastic resin intended for use in the anode elements of secondary batteries to make the electrically insulating thermoplastic material a conductive material and to impart energy storage properties. In this way, it has been made possible to use a thermoplastic composite material developed with electrical conductivity and energy storage properties as an alternative to the traditionally used carbon derivated to single-layer anode without the use of copper plate.

### TECHNICAL FIELD

A reinforcement and/or filler element is added to the thermoplastic resin intended for use in the anode elements of secondary batteries to make the electrically insulating thermoplastic material a conductive material and to impart energy storage properties. In this way, it makes possible to use a thermoplastic composite material developed with electrical conductivity and energy storage properties as an alternative to the traditionally used graphite single-layer anode without the use of copper plate.

### PREVIOUS ART

One of the most important problems of our age is to lower costs in generation and storage of energy. As some of the most well-founded branches of fundamental sciences, electrochemical studies and improver material science carry great importance in discovery and development of clean and renewable energy sources. The demand for energy storage devices grows every passing day in proportion to renewable energy sources which prove to be unstable.

As a general reference, systems used in energy storage which convert chemical energy into electrical energy are called as batteries. Types of batteries widely used today include primary batteries and secondary batteries. Primary batteries are non-chargeable batteries, while secondary batteries are chargeable type. Secondary batteries are more widely used due to being re-useable and more suitable for environmentally friendly sensibilities. Having become popular in recent years, secondary batteries, especially lithium ion (Li-ion) batteries are subject to increasing numbers of research and development projects. In recent years there have been intensive studies on development of new generation composite anode and cathode electrodes with low cost and high efficiency.

Requirements in communications to defence industry to medicine to transport and many more fields are rapidly met with the developments and goals in technology.

In the 21^{st} century, mobile electronic devices (cell phones, cameras, computers, etc.) have significant effect on our daily life. Furthermore, most electronic devices we daily-drive have become compatible with wireless use in-line with technological developments. The foremost condition for use of such wireless devices is having a mobile energy source. This energy source must have a high energy density, long useful life and short charge time as well as being environmentally harmless. In this context, rechargeable secondary batteries are widely used to supply energy in electronic device technologies. Many studies argue that as petroleum resources are exhausted use of electrical vehicles will increase and this arising energy storage need will be met by new generation secondary batteries.

State known of the technique, the most popular type of batteries used today are Li-ion batteries. Li-ion batteries comprise a lithium source (lithium metal, lithium salt or organo-lithium compounds) as a cathode material, carbon-based compounds, ceramics or metallic salts as a host anode material, and a non-aqueous organic solution or a solid phase electrolyte as the electrolyte material.

In the current state of the technique instability of the graphite, generation of lithium dendrites, problems in cycle number, inefficiency in energy capacity, lower energy density, difficulty of production, safety problems and environmental hazard posed by limited recyclability constitute barriers against spread of secondary batteries.

Solutions in the current state of the technique generally trend towards materials like carbon based composites, polymeric composites, ceramic composites, metallic composites having electrically conductive properties. In the current state of the technique an article published on Volume 135 of the Journal of Power Sources in September 2004 under the title of Pyrolysis of an alkyltin/polymer mixture to form a tin/carbon composite for use as an anode in lithium-ion batteries mentions polymeric materials with known electrical conductivity. While anode materials studied in this context provide the desired discharge capacity, energy density and cycle number gains, difficulty of production and production line (or production process) costs have led to problems in launching such products.

As synthetic or natural implementation of the conventionally used graphite material poses various difficulties, processing of this material for use as an anode requires large amounts of effort and cost.

Furthermore, an article published in Volume 152 of the Mechanics of Materials journal in January 2021 under the title of Modelling electrolyte-immersed tensile property of polypropylene separator for lithium-ion battery covers production of electrolytes. The said work covers studies generally using thermoplastics, particularly polypropylene (PP) and polyethylene (PE) in production of electrolytes. Literature also includes studies where thermoplastics are generally utilised for thermal energy storage purposes. For example, an article published on Volume 15 of the Materials Today Communications journal in June 2018 under the title of 3D printable thermoplastic polyurethane blends with thermal energy storage/release capabilities mentions thermal storage elements made of thermoplastics. However, it shows that thermoplastic composite materials were not used for electrical energy storage.

### PURPOSE OF THE INVENTION

Thermoplastics have become one of the most widely used materials in the modern life in recent years due to their superior mechanical properties, thermal stability, ease of processing and recyclability.

Thermoplastics constitute a polymer class which can be softened and melted by application of heat and processed in their heat softened form (e.g. thermal forming) or in their melted form (e.g. extrusion and injection moulding). Thermoplastic polymers can be reprocessed again and again by heat treatment and can be recycled to produce new products. The most widespread production processes used to produce thermoplastic pieces include injection moulding, blowing moulding and heat forming.

In addition to their recycling advantage, thermoplastics also have high flexibility and impact resistance. They can also be combined together using various welding techniques like resistance welding, vibration welding and ultrasonic welding. Furthermore, shaping times of thermoplastic pieces are also quite low.

While thermoplastics are widely processed and utilised across the world, it is ascertained that they have not been tested for anode material in secondary batteries. It is contemplated thermoplastics would prove a good host for lithium ions due to their molecular structure (long chain structures) and prove to be an anode material with high charge-discharge capacity by providing porous and electrically conductive structures with reinforcements and/or fillers.

Production of thermoplastic based composite materials can be easily achieved by compounding with twin screw extruder method. Compared to the anode production method in the current state of the art the compounding is both more practical and faster. In addition, being easier to form, thermoplastics open the door to faster, more varied and easier methods for processing after being produced as anode materials.

The purposes in using thermoplastic based composite materials as anode material of secondary batteries are as listed below:
To provide an increase in discharge capacity, energy capacity and cycle number of the anode;
To ensure standardisation and facilitation of the anode production process and to lower production costs; and
To prevent known safety problems with lithium-ion batteries (explosion, heating, ignition, etc.) and to ensure anode material can be recycled by using thermoplastic based composite materials in anode production.

### DETAILED DESCRIPTION OF THE INVENTION

### Description of the Images:

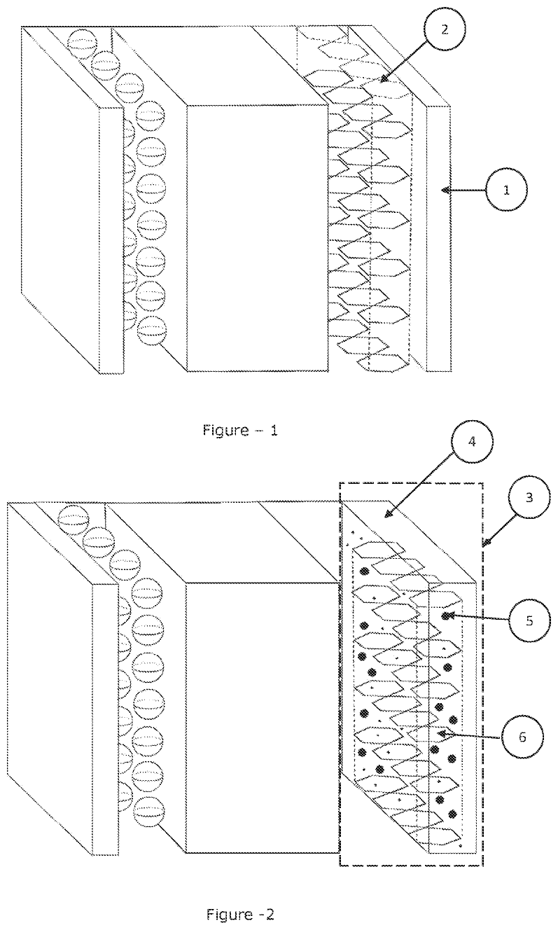

FIG. 1 Schematic battery cell representation of the current technique

FIG. 2 Schematic battery cell representation of the invention

1. Copper plate
2. Carbon derivated active material
3. Single layer anode
4. Thermoplastic matrix
5. Metal and/or metal salt
6. Carbon derivate material

The general view of Li-ion batteries consisting of secondary batteries in the state of the art is given in FIG. 1. The anode part of the Li-ion batteries of the current technique, shown in FIG. 1, is formed by the combination of the carbon-derived active material (2) applied on the copper plate (1). The single-layer anode includes thermoplastic matrix (4), metal and/or metal salt (5), carbon-derived material (6), organometallic, ceramic compounds, fillers, binders in secondary batteries.

The largest reason for thermoplastics not being able serve as an anode material on their own is the fact that plastics are electrically insulating materials due to their nature. In studies in this context thermoplastic based composite materials are developed in order to provide thermoplastic parts which are electrically conductive and suitable for energy storage. In scope of these studies, it is discovered that combination of thermoplastic materials with metals and/or metal salts and/or organo-metallic compounds, ceramic compounds and/or carbon derivative reinforcement and/or filling elements improve their conductivity, energy storage and stability properties.

Thermoplastic based composite materials enhanced with electrical conductivity and energy storage properties have a good potential to be used as anode materials in secondary batteries. This way, the cycle number of the battery and its suitability for recycling are improved. Use of thermoplastic based composite materials as an anode material and decrease of the density of the anode material allows an increase in useable amount of active material. In result of this, charge-discharge capacity would be increased, and formation of lithium dendrites would be prevented in the utilised reinforcement and/or filling materials.

Polymer materials utilise at least one of the following materials as the thermoplastic matrix (4) for the single layer anode (3): Polyethylene (PE), Polypropylene (PP), Polystyrene (PS), Polyethylene terephthalate (PET or PTFE), Polyamide (PA) (Nylon), Polyvinyl chloride (PVC), Polycarbonate (PC), Acrylonitrile butadiene styrene (ABS), Polyvinylidene chloride (PVDC), Polybutylene Terephthalate (PBT), Polyphenylene Sulphide (PPS), Syndiotactic Polystyrene (SPS), Polyether ether ketone (PEEK), Polyketones (POK). In order to endow electrical conductivity property to polymers which are naturally electrical insulators a thermoplastic based composite material formula is created by adding metal, metal salts, silicon derivatives and organo-metallic compounds, as well as carbon derivatives (graphite, graphene, carbon nanotubes, carbon fibres, etc.). Twin screw extruders are used in production of thermoplastic based composite materials.

During production of single layer anode made of thermoplastic composite material using twin screw extruders, metals and/or metal salts, ceramic compounds, organo-metallic compounds and carbon derivatives and primary and secondary antioxidants are added into the melted thermoplastic. This melted material is passed through the mould in front of the extruder and cut by help of the pelletizer to obtain granules.

Main mechanism used in an extrusion operation include feeding, melting and homogenous mixing. The L/D ratio of the extruder has an effect on mixing and homogeneity of the output. Material output speed of the extruder depends on the screw revolution rate, barrel temperature, screw configuration and viscosity of the solution.

According to these parameters 30% to 80% by weight thermoplastic material is used in thermoplastic based composite materials produced by extrusion method. 3% to 30% by weight metal and/or metal minerals and organo-metallic compounds and 15% to 60% by weight carbon derivative materials and 5% to 30% by weight ceramic compounds and 1% to 10% by weight binding additives and/or coupling agents are used as reinforcement and/or filling elements. These materials are formed into granules as a result of extrusion.

Primarily, granulated thermoplastic-based composite materials are formed into films with a plastic film machine or into sheets by injection. The thickness of film/sheet materials should be in the range of 0.1-1.00 mm.

The process steps for use of a thermoplastic based composite material as anode material in Li-ion type secondary batteries are detailed below;
Binders and additives required for the anode material were added to the single layer anode during the extrusion process. A flexible structure has been given to the material with the form of plastic film and/or sheet.
The anode material produced by extrusion is single-layered, and it is ready for use in secondary batteries directly as an anode without applying a physical or chemical process and without a copper collector.
This processed anode material is shaped according to the desired battery type (pen battery, button cell, etc.) and made ready for the battery production process. The battery cell can be prepared under an inert atmosphere with single layer anode, which is ready for the battery production process, cathode, electrolyte and separators.

The thermoplastic based composite material developed as detailed above can also be used in various types of batteries in any field of application (automotive, industry, satellites, etc.).

1. An anode intended for use in secondary batteries, characterised by;
a. A composite material comprised of 30% to 80% by weight thermoplastic matrix (4);
b. 3% to 30% by weight metal and/or metal salts (5) and organometallic compounds;
c. 5% to 30% by weight ceramic compounds and/or 15% to 60% by weight carbon derivatives (6);
d. 1% to 10% by weight binder additives and/or coupling agents;
is that thermoplastic based composite materials as a single layer anode.

2. A production method for a single layer anode without copper plate intended for use in secondary batteries, characterised by the process steps including;
a. Forming the material processed by twin screw extruder method as thermoplastic composite film and/or sheet with a thickness of 0.1-1.0 mm;
b. Film and/or sheet anode is formed according to the desired battery type and made ready for the battery production process;
c. The prepared anode is kept in an inert atmosphere so that it is ready for the battery production process, removing water and oxygen;
d. Using the anode, from which water and oxygen are removed, as electrode cells for secondary battery production.

3. A production method of anode in accordance with claim 2 characterised by; single layer anode produced by twin screw extruder method.

4. A production method of anode in accordance with claim 2 characterised by; Thermoplastic-based composite materials is used with additives, fillers, binders, conductivity enhancers, anhydrous organic binders by twin screw extruder method.
